(19) United States
(12) Patent Application Publication
(10) Pub. No.: US 2013/0251924 A1
(43) Pub. Date: Sep. 26, 2013

(54) MACROSPHERE CARBON FIBER REDUCTION

(71) Applicants: Majdi Haddad, Pcabody, MA (US); Lou Watkins, Stoughton, MA (US)

(72) Inventors: Majdi Haddad, Pcabody, MA (US); Lou Watkins, Stoughton, MA (US)

(21) Appl. No.: 13/426,218

(22) Filed: Mar. 21, 2012

(51) Int. Cl. B32B 1/00; B32B 5/26

(52) U.S. Cl. 428/34.5

(57) ABSTRACT

A macrosphere comprises a multilayered spherical wall that includes (i) a first wall that includes a first epoxy and first fibers (ii) a second wall that includes a second epoxy and second fibers and (iii) a third wall that includes a third epoxy and glass micro spheres, wherein the third wall is located between the first and second walls and the multilayered spherical wall forms a hollow chamber. The fibers may be carbon fibers. However, it is contemplated that glass fibers may also be used rather than carbon fibers. In addition, it is contemplated that the first layer may be formed using glass fibers, while the second layer is formed using carbon fibers.

### BACKGROUND OF THE INVENTION

The invention relates to the field of hollow macrospheres that may be used with syntactic foam for buoyancy products, and in particular to hollow macrospheres having a multi-layered spherical wall construction.

Macrospheres have been an important component in syntactic foam buoyancy construction for many years. Macrospheres are typically fiberglass, sealed, seamless, hollow, air and water tight spheres. Other high strength advanced composite type fibers (e.g., carbon fibers, aramid, etc.) may also be used rather than fiberglass. Referring to FIG. 1, a macrosphere 10 may be about 6.0 to 10.0 mm in diameter and have a monolithic wall 12 of 0.75 mm. Typical macrosphere monolithic walls are fiberglass, using milled glass fibers in an epoxy resin binder to form the spherical shell. However, as the offshore oil industry moved out into deeper water and greater pressures, the need for stronger macrospheres increased. The use of carbon fiber instead of glass fiber has led to macrospheres of much higher specific strength (strength divided by density), but has also greatly increased cost and led to serious supply difficulties.

There is a need for a high compressive strength macrosphere that uses a relatively small amount of carbon fiber.

### SUMMARY OF THE INVENTION

Briefly, according to an aspect of the present invention, a macrosphere comprises a multilayered spherical wall that includes (i) a first wall that includes a first epoxy and first fibers (ii) a second wall that includes a second epoxy and second fibers and (iii) a third wall that includes a third epoxy and glass microspheres, wherein the third wall is located between the first and second walls and the multilayered spherical wall forms a hollow chamber.

The first and second fibers may be carbon or glass fibers. In another embodiment wherein the first wall is radially interior with respect to the second and third walls, and the first fibers may include glass fibers and the second fibers may include carbon fibers.

These and other objects, features and advantages of the present invention will become apparent in light of the following detailed description of preferred embodiments thereof, as illustrated in the accompanying drawings.

### BRIEF DESCRIPTION OF THE DRAWINGS

FIG. 1 is a cross sectional illustration of a prior art monolithic macrosphere;

FIG. 2 is a cross sectional illustration of a multilayered spherical wall macrosphere; and

FIG. 3 is a flow chart of a process for manufacturing the multilayered spherical wall macrosphere of FIG. 2.

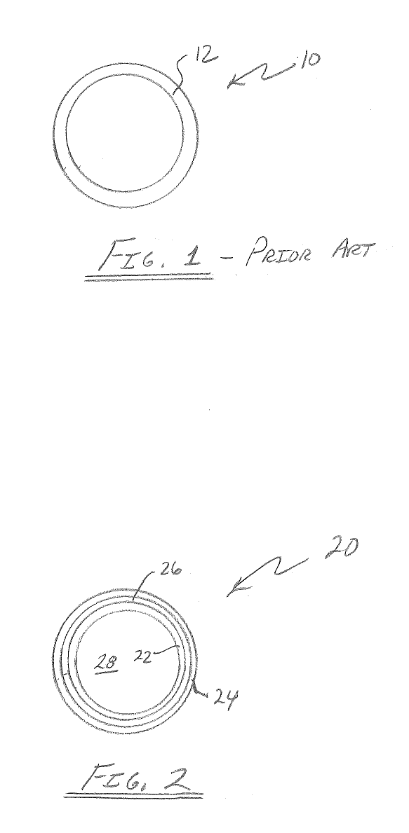

### DETAILED DESCRIPTION OF THE INVENTION

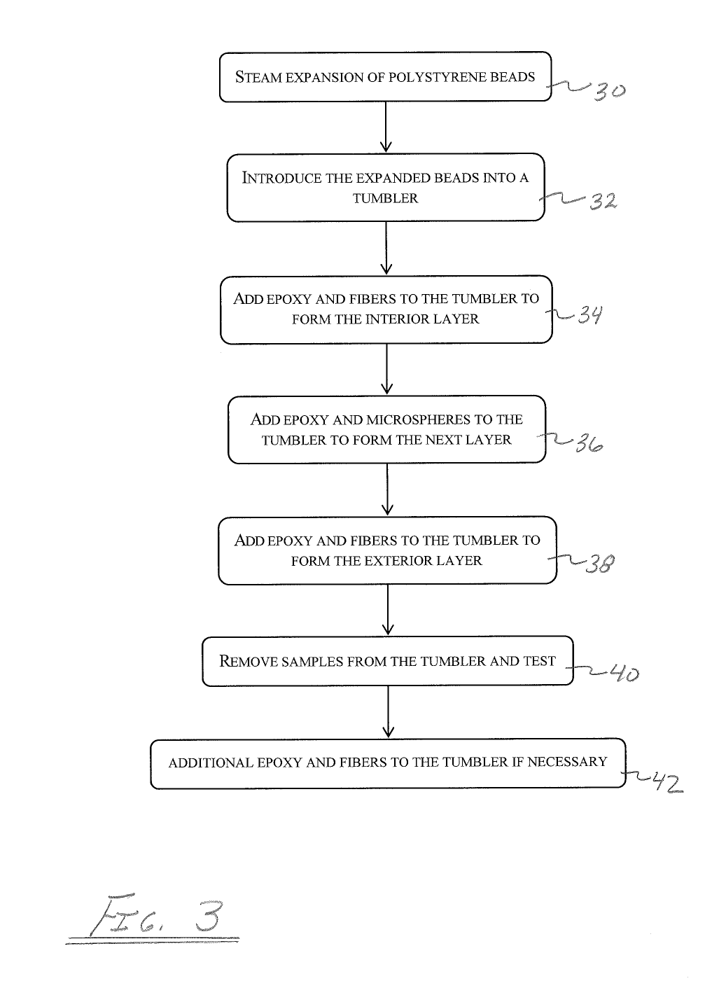

FIG. 2 is a cross sectional illustration of a multilayered spherical wall macrosphere 20. The multilayered spherical wall comprises a first layer 22, second layer 24 and a third layer 26. The first wall layer may include a first epoxy and first fibers, and the second layer 24 may include a second epoxy and second fibers. The third layer 26 may include a third epoxy and glass microspheres, and the third layer is located between the first and second layer and the multilayered spherical wall forms a hollow chamber 28.

The first epoxy may be Bisphenol-A with suitable amine hardener and the first fibers of the first layer 22 may be carbon fibers. The ratio of the first epoxy versus the first fibers of the first wall may about 50 ppw and 50 ppw, respectively. The second epoxy may be same as the first epoxy and the second fibers of the second layer 24 may be carbon fibers. The ratio of the second epoxy versus the second fibers of the second layer may about 50 ppw and 50 ppw, respectively.

The thickness of the multilayered spherical wall may be about 0.010 to 0.020 inches. In one embodiment the layers 22, 24 and 26 may each be about 0.005 inches. Of course the thickness of the individual layers may be adjusted based upon the desired performance of the macrosphere.

The third epoxy may be the same as the first and second epoxy and the glass microspheres may be for example about 100 microns in diameter. The ratio of the third epoxy versus the glass microspheres of the third layer may about 70 to 80 ppw and 20 to 30 ppw, respectively.

The second layer 24 may include a higher density of carbon fiber in comparison to the first layer 22. This allows a majority of the carbon fibers to be located at the radial extremities of the multilayered spherical wall, where they act most effectively in tension and compression. In addition, it increases the thickness of the wall without materially increasing the total weight, thus increasing the specific strength of the wall. Notably, the macrosphere 20 can achieve equivalent compressive strength while using significantly less carbon fiber (e.g., about 50%) in comparison to conventional monolithic macrospheres.

As an example of an improvement offered by the invention, conventional monolithic macrospheres made with epoxy resin and carbon fiber may have a collapse strength of about 1,000 psi and a true particle density of about 12.0 pcf. Changing to a multilayered construction allows a choice of favorable outcomes: (i) the new spheres may be made with the same properties using only about half as much carbon fiber, or (ii) the new spheres may be at least about 2.0 pcf lighter with the same strength, or (iii) the new sphere may have the same density but be about 500 psi stronger.

FIG. 3 is a flow chart illustration of a process for manufacturing the multilayered spherical wall macrosphere 20 of FIG. 2. In step 30 steam expansion is performed, and this step includes feeding small crystals of polystyrene beads into the base of the rotating container that includes an agitator. A flowing agent Pentane is also introduced into the rotating container along with steam. The temperature of the steam is the softening point of polystyrene and also the expansion point of Pentane.

In step 32 the expanded beads (e.g., now about 1-2 pounds/ft³) are then conveyed by air into a tumbler (e.g., a cylinder inclined from the horizontal by about 30°). Epoxy is then added in step 34 to the tumbler (e.g., sprayed in) along with fibers (e.g., carbon fibers). Since the epoxy is a liquid it spreads itself over the expanded beads and the fibers adhere to the epoxy to form the first wall 22.

In step 36, to form the third layer 26, microspheres are added to the tumbler along with the epoxy, rather than the fibers. In step 38 the second layer 24 is formed by no longer adding the microspheres, but now adding the fibers again along with the epoxy.

Once dried and cured a sample of a few multilayered coated macrospheres may be removed from the tumbler in step 40, to assess their strength. If the strength is sufficient and other quality assurance checks are okay, then the macrospheres within the tumbler are ready to be used. Otherwise, if the macrosphere wall is not strong enough, then additional epoxy and fibers are added to the tumbler in step 42 to increase the thickness of the second layer 26. The internal temperature of the tumbler should be about 100° F. (if the internal temperature of the tumbler is too hot then the polystyrene will shrink).

The fibers may be carbon fibers. However, it is contemplated that glass fibers may also be used rather than carbon fibers. In addition, it is contemplated that the first layer may be formed using glass fibers, while the second layer is formed using carbon fibers.

The macrospheres may be used for riser modules, fairings, riser drag reduction devices, distributed buoyancy, ROV floats, et cetera.

Although the present invention has been shown and described with respect to several preferred embodiments thereof, various changes, omissions and additions to the form and detail thereof, may be made therein, without departing from the spirit and scope of the invention.

What is claimed is:

1. A macrosphere comprising:
a multilayered spherical wall comprising (i) a first wall that includes a first epoxy and first fibers (ii) a second wall that includes a second epoxy and second fibers and (iii) a third wall that includes a third epoxy and glass microspheres, wherein the third wall is located between the first and second walls and the multilayered spherical wall forms a hollow chamber.

2. The macrosphere of claim 1, wherein the first and second fibers comprise carbon fibers.

3. The macrosphere of claim 1, wherein the first wall is radially interior with respect to the second and third walls, and the first fibers include glass fibers and the second fibers comprise carbon fibers.

4. The macrosphere of claim 1, wherein the first wall is radially interior with respect to the second and third walls, and the first fibers include glass fibers and the second fibers comprise carbon fibers.
